(19) United States
(12) Patent Application Publication
(10) Pub. No.: US 2010/0189193 A1
(43) Pub. Date: Jul. 29, 2010

(54) POLAR MODULATION TRANSMITTER AND POLAR MODULATION TRANSMISSION METHOD

(75) Inventor: Ritsu Miura, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/376,957

(22) PCT Filed: Aug. 23, 2006
(86) PCT No.: PCT/JP2006/316526

§ 371 Date: Feb. 9, 2009

(51) Int. Cl. H04L 27/20

(52) U.S. Cl. 375/308

(57) ABSTRACT

A power amplifier (106) has a linear operation mode for performing power amplification by use of a linear operating domain in an input-output power characteristic and a saturation operation mode for performing power amplification by use of a saturation operation domain in the input-output power characteristic. An amplitude control section (112) outputs gain control voltage data for controlling a gain of a gain control amplifier (105) and power control voltage data for controlling a source voltage of a power amplifier (106) in accordance with a transmission power setting value, thereby causing the power amplifier (106) to operate in any one of the operation modes. An amplitude correction section (122) outputs a reference correction value for correcting the gain control voltage data and the power control voltage data output from the amplitude control section (112) in accordance with the operation mode determined by a mode determination section (110) and temperature information detected by a temperature sensor (130).

### TECHNICAL FIELD

The present invention relates to a polar modulation transmitter and a polar modulation transmission method.

### BACKGROUND ART

In relation to a wireless communications device that supports a plurality of wireless communications system, a polar modulation transmitter that obviates selection of a modulation scheme, such as a linear modulation scheme (e.g., QPSK (Quadrature Phase Shift Keying)) and a nonlinear modulation scheme GMSK (e.g., Gaussian filtered Minimum Shift Keying)), has been developed.

The polar modulation transmitter separates an input modulation signal into phase information and amplitude information, inputs a phase-modulated signal with a fixed envelope into a power amplifier that is in the middle of performing switching operation, and modulates a source voltage of the power amplifier by amplitude information, thereby acquiring a modulation signal which is a combination of phase information and amplitude information.

The polar modulation transmitter controls transmission power by controlling the source voltage of the power amplifier. Therefore, a dynamic range of transmission power of the polar modulation transmitter serving as a transmitter is regulated within a source voltage range where the power amplifier can operate, and difficulty is encountered in applying the polar modulation transmitter to a wireless communications system of a code division multiplexing access communications scheme, and the like, that requires a wide dynamic range of transmission power.

Accordingly, for instance, Patent Document 1 shows a transmitter proposed as a transmitter that exhibits superior power efficiency and a wide control range of transmission output power, wherein the transmitter has a first mode for causing a high-frequency power amplifier to operate as a nonlinear amplifier and a second mode for causing the high-frequency power amplifier as a linear amplifier. The transmitter performs, in the first mode, amplitude modulation of a transmission signal at a source voltage of the high-frequency power amplifier and control of an average output level, and performs, in the second mode, control of the average output level of the transmission signal at a preceding stage of the high-frequency power amplifier and amplitude modulation of the transmission signal whose average output level has been controlled.

Patent Document 1: JP-A-2005-064662

### DISCLOSURE OF THE INVENTION

### Problem that the Invention is to Solve

However, in the above-described transmitter, when a variation arises in temperature, or the like, for reasons of a characteristic of the power amplifier, and the like, employed in the transmitter, an optimum value, such as a source voltage imparted to the power amplifier, may change. Moreover, an error in the optimum value may not become constant depending on an operation mode of the power amplifier, whereupon linearity of transmission power may be deteriorated from one operation mode to another by common, uniform error correction under the quadrature modulation scheme.

FIG. 6 is a descriptive view showing an error in transmission output power attributable to a temperature change, showing actual transmission output power responsive to a transmission power setting value. A transmission power setting value Psw is power for switching an operation mode of the power amplifier. When a value equal to or greater than the transmission power setting value Psw is attained, the power amplifier is assumed to be caused to operate in the saturation mode. When a value less than the transmission power setting value Psw is attained, the power amplifier is assumed to be caused to operate in a linear mode.

In FIG. 6, a characteristic 601 designates an ideal relationship between actual transmission power and a transmission power setting value, and a characteristic 602 shows a case where an error ascribable to a temperature change, and the like, is included. Thus, it is seen from the characteristic 602 that linearity of transmission power is impaired from one operation mode to another.

The present invention has been conceived in light of the circumstance and aims at providing a polar modulation transmitter and a polar modulation transmission method that enable high-speed tracking of a change in transmission power while lessening an error in transmission power.

### Means for Solving the Problem

First, the present invention provides a polar modulation transmitter comprising: an amplitude and phase detection section that separates an input modulation signal into phase information and amplitude information; a phase modulation section that modules a predetermined carrier wave signal in accordance with the phase information and that outputs a phase-modulated signal; a gain control amplifier that amplifies the phase-modulated signal; a power amplifier that has operation modes including a linear operation mode for performing power amplification by use of a linear operating domain in an input-output power characteristic and a saturation operation mode for performing power amplification by use of a saturation operation domain in the input-output power characteristic and that amplifies a signal output from the gain control amplifier; a transmission power control section that outputs control signals including a gain control signal for controlling a gain of the gain control amplifier and a power control signal for controlling a source voltage of the power amplifier in accordance with a transmission power setting value for designating transmission output power so as to cause the power amplifier to operate in any one of the operation modes; a power supply section that subjects the power control signal to amplitude modulation in accordance with the amplitude information and that supplies the amplitude-modulated power control signal to the power amplifier; a state quantity detection section that detects a state quantity representing a state of the power amplifier; an operation mode determination section that determines an operation mode of the power amplifier in accordance with the transmission power setting value; and a first correction section that acquires a first correction value in accordance with the determined operation mode and the detected state quantity and that corrects the control signal in accordance with the first correction value.

By the configuration, a control signal is corrected in accordance with the operation mode of the power amplifier and the detected state quantity; hence, a change in transmission power can be followed at high speed while an error in transmission power is lessened.

Second, the present invention relates to the first-described polar modulation transmitter, the transmitter further comprising: a first power detection section that detects output power of the power amplifier; and a second correction section that compares the output power detected by the first power detection section with the transmission power setting value to calculate a second correction value, and that corrects the first correction value in accordance with the second correction value.

By the configuration, the control signal is corrected upon reflection of a result of a comparison between the output power of the power amplifier and the transmission power setting value; hence, high-precision transmission power control can be performed. Moreover, the control signal is corrected in accordance with the first correction value; hence, the amount of correction made by the feedback loop becomes smaller. Therefore, a conversion time of feedback can be shortened, and a change in transmission power can be followed at high speed.

Third, the present invention relates to the second-described polar modulation transmitter, the transmitter further comprising a correction value updating section that updates, as a new first correction value, the first correction value corrected by the second correction section and that supplies the new first correction value to the first correction section.

By the configuration, a first correction value corrected by the second correction section is updated as a new first correction value and supplied to the first correction section. Hence, even when transmission is temporarily suspended or when the power of the transmitter is turned off, the updated first correction value is retained, and hence the accuracy of the first correction value is enhanced, and a change in transmission power can be followed at higher speed. Further, even when a change arises in an optimum correction value for reasons of a secular change, and the like, the first correction value is updated to an optimum correction value, and hence high-speed tracking of a change in transmission power can be maintained.

Fourth, the present invention relates to the first-described polar modulation transmitter, the transmitter further comprising: a second power detection section that detects output power of the gain control amplifier; a third correction section that compares the output power detected by the second power detection section with a gain control signal output from the transmission power control section to calculate a third correction value, and that corrects the gain control signal in accordance with the third correction value, wherein the first correction section corrects the power control signal in accordance with the first correction value.

By the configuration, the gain control signal input to the gain control amplifier is corrected by use of a feedback loop, and the power control signal input to the power amplifier corrects a power control signal that controls the power of the power control amplifier in accordance with the detected state quantity. The signal amplified by the gain control amplifier is a constant envelope; hence, a time constant of the feedback loop can be reduced, and a change in transmission power can be tracked at high speed. Since an error in power control performed by the gain control amplifier is kept small at all times, the essential requirement for the transmission power control section is to correct only transmission power of the power amplifier. Therefore, when transmission power control using a feedback loop is performed, the scale of a circuit can be reduced.

Fifth, the present invention relates to any of the first-described to fourth-described polar modulation transmitters, the transmitter further comprising: a storage section that stores a correction value appropriate to the operation mode and the state quantity, wherein the first correction section reads the correction value stored in the storage section to acquire the first correction value.

By such a configuration, a first correction value is read by use of a correction value previously stored in the storage section. Hence, a change in transmission power can be followed at high speed by a simple configuration while an error in transmission power is lessened.

Sixth, the present invention relates to any of the first-described to fifth-described polar modulation transmitters, wherein the state quantity detection section has a temperature sensor for detecting a temperature.

By the configuration, a change in transmission power can be tracked at high speed while an error in transmission power attributable to a temperature change is lessened.

Seventh, the present invention provides a wireless communications device equipped with any of the first-described to sixth-described polar modulation transmitters.

By the configuration, a change in transmission power can be tracked at high speed while an error in transmission power is lessened.

Eighth, the present invention provides a polar modulation transmission method comprising the steps of: separating an input modulation signal into phase information and amplitude information; modulating a predetermined carrier wave signal in accordance with the phase information and outputting a phase-modulated signal; amplifying the phase-modulated signal by a gain control amplifier; amplifying a signal output from the gain control amplifier by a power amplifier that has operation modes including a linear operation mode for performing power amplification by use of a linear operating domain in an input-output power characteristic and a saturation operation mode for performing power amplification by use of a saturation operation domain in the input-output power characteristic; outputting control signals including a gain control signal for controlling a gain of the gain control amplifier and a power control signal for controlling a source voltage of the power amplifier in accordance with a transmission power setting value for designating transmission output power so as to cause the power amplifier to operate in any one of the operation modes; subjecting the power control signal to amplitude modulation in accordance with the amplitude information and supplying the amplitude-modulated power control signal to the power amplifier; detecting a state quantity representing a state of the power amplifier; determining an operation mode of the power amplifier in accordance with the transmission power setting value; and acquiring a first correction value in accordance with the determined operation mode and the detected state quantity and making a correction to the control signal in accordance with the first correction value.

By the method, a change in transmission power can be followed at high speed while an error in transmission power is lessened.

### ADVANTAGE OF THE INVENTION

The present invention can provide a polar modulation transmitter and a polar modulation transmission method that enable high-speed tracking of a change in transmission power while lessening an error in transmission power.

### BRIEF DESCRIPTION OF THE DRAWINGS

FIG. 1 A block diagram showing the general configuration of a polar modulation transmitter of a first embodiment of the present invention.

FIG. 2 A descriptive view of operation of the polar modulation transmitter of the first embodiment of the present invention.

FIG. 3 A block diagram showing the general configuration of a polar modulation transmitter of a second embodiment of the present invention.

FIG. 4 A block diagram showing the general configuration of a polar modulation transmitter of a third embodiment of the present invention.

FIG. 5 A descriptive view of operation of the polar modulation transmitter of the third embodiment of the present invention.

FIG. 6 A descriptive view showing an error in transmission output power induced by a temperature change.

### DESCRIPTIONS OF THE REFERENCE NUMERALS

100, 300, 400 POLAR MODULATION TRANSMITTER
101 MODULATION SIGNAL INPUT TERMINAL
102 AMPLITUDE AND PHASE DETECTION SECTION
103, 115, 116 D/A CONVERTER (DAC)
104 PHASE MODULATION SECTION
105 GAIN CONTROL AMPLIFIER (VGA)
106 POWER AMPLIFIER (PA)
107 TRANSMISSION SIGNAL OUTPUT TERMINAL
108 TRANSMISSION POWER SETTING INPUT TERMINAL
109 MULTIPLIER
110 MODE DETERMINATION SECTION
111, 119, 120 STORAGE SECTION
112 AMPLITUDE CONTROL SECTION
113, 114, 125, 126 ADDER
117 POWER INPUT TERMINAL
118 POWER CONTROL SECTION
121, 302 SELECTOR
123, 401 POWER VALUE COMPARISON SECTION
124, 402 CORRECTION VALUE COMPUTING SECTION
127, 129, 403 A/D CONVERTER (ADC)
128, 504 POWER DETECTION SECTION
130 TEMPERATURE SENSOR
301 CORRECTION VALUE UPDATING SECTION

### BEST MODES FOR IMPLEMENTING THE INVENTION

### First Embodiment

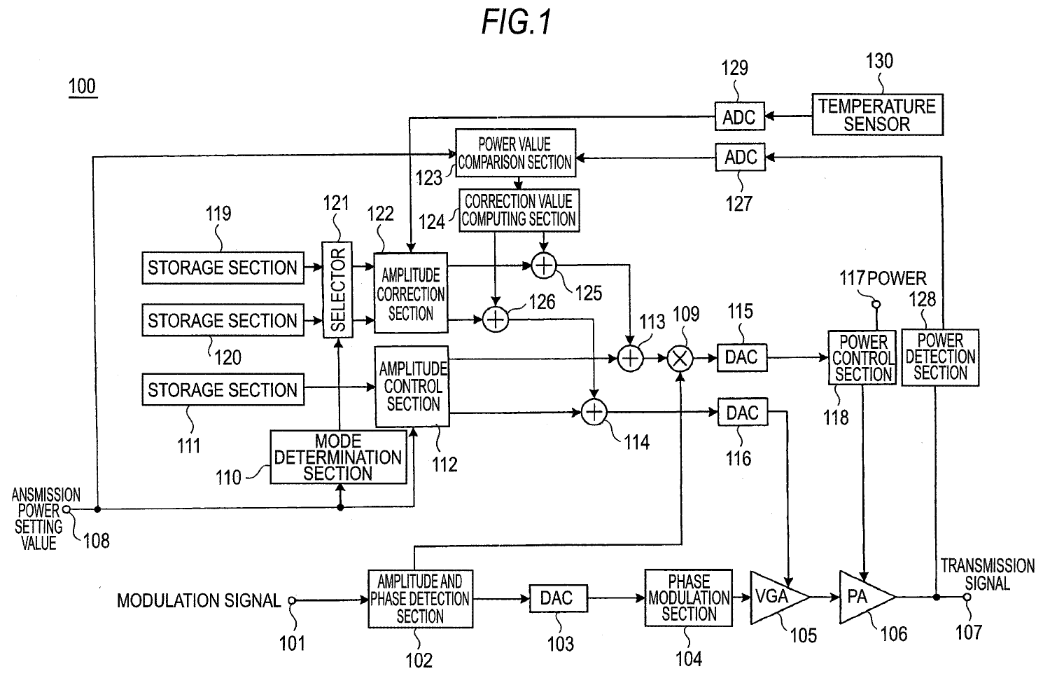

FIG. 1 is a block diagram showing the general configuration of a polar modulation transmitter of a first embodiment of the present invention. As shown in FIG. 1, a polar modulation transmitter 100 of the present embodiment has a modulation signal input terminal 101; an amplitude and phase detection section 102; D/A converters (DAC) 103, 115, and 116; a phase modulation section 104; a gain control amplifier (VGA) 105; a power amplifier (PA) 106; and a transmission signal output terminal 107.

The polar modulation transmitter 100 has a transmission power setting input terminal 108; a multiplier 109; a mode determination section 110; storage sections 111, 119, and 120; an amplitude control section 112; adders 113, 114, 125, and 126; a power input terminal 117; a power control section 118; a selector 121; an amplitude correction section 122; a power value comparison section 123; a correction value computing section 124; A/D converters (ADC) 127, 129; a power detection section 128; and a temperature sensor 130.

The amplitude control section 112 functions as an example of a transmission power control section; the multiplier 109 and the power control section 118 function as an example of a power supply section; the amplitude correction section 122 functions as an example of a first correction section; the power value comparison section 123 and the correction value computing section 124 function as an example of a second correction section; and the power detection section 128 functions as an example of a first power detection section.

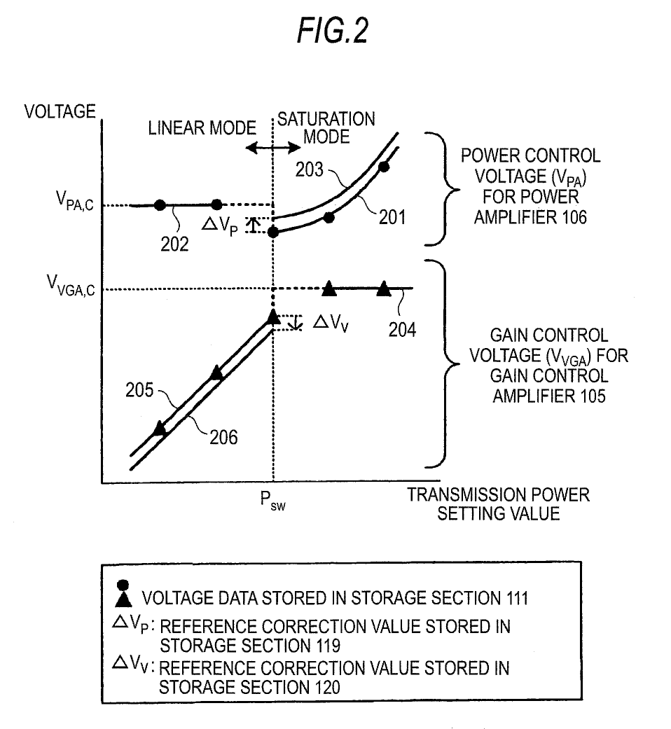

FIG. 2 is an explanatory view of operation of the polar modulation transmitter of the first embodiment of the present invention, showing voltage data stored in the storage sections 111, 119, and 120. A characteristic 201 designates a characteristic curve of a power control voltage of the power amplifier 106 achieved in a saturation mode; a characteristic 202 designates a characteristic curve of the power control voltage of the power amplifier 106 achieved in a linear mode; a characteristic 203 designates a characteristic curve of the power control voltage of the power amplifier 106 achieved in the saturation mode when a temperature change arises; a characteristic 204 designates a characteristic curve of a gain control voltage of the gain control amplifier 105 achieved in the saturation mode; a characteristic 205 designates a characteristic curve of the gain control voltage of the gain control amplifier 105 achieved in the linear mode; and a characteristic 206 designates a characteristic curve of the gain control voltage of the gain control amplifier 105 achieved in the linear mode when a temperature change arises.

An embodiment shown in FIG. 2 provides an example showing, in a saturation mode, a temperature characteristic for which only the power amplifier 106 requires a correction and, in a linear mode, a temperature characteristic for which only the gain control amplifier 105 requires a correction.

Operation of the polar modulation transmitter 100 will now be described by reference to FIGS. 1 and 2.

When a modulation signal is input to the modulation signal input terminal 101, the amplitude and phase detection section 102 separates an input modulation signal into phase information and amplitude information. The D/A converter 103 converts the phase information output from the amplitude and phase detection section 102 from a digital signal into an analogue signal. The phase modulation section 104 modulates a predetermined carrier wave signal of a wireless frequency band, and the like, in accordance with the phase information output from the D/A converter 103 and outputs a phase-modulated signal. The gain control amplifier 105 adjusts the power of the phase-modulated signal, and the power amplifier 106 subjects a signal output from the gain control amplifier 105 to amplitude modulation and output power adjustment and outputs the signal to the transmission signal output terminal 107.

In accordance with a transmission power setting value input from the transmission power setting input terminal 108, the amplitude control section 112 outputs a control signal including gain control voltage data that are an example of a gain control signal for controlling the gain of the gain control amplifier 105 and power control voltage data that are an example of a power control signal for controlling a source voltage of the power amplifier 106. The gain control voltage data and the power control voltage data output from the amplitude control section 112 are subjected to corrections (details thereof will be provided later) in the adders 113 and 114. The transmission power setting value input to the transmission power setting input terminal 108 is a setting value for designating transmission output power (power of a signal output from the transmission signal output terminal 107) output by the polar modulation transmitter 100.

The multiplier 109 multiplies an output from the adder 113 by the amplitude information output from the amplitude and phase detection section 102 and outputs amplitude-modulated power control voltage data. The D/A converter 115 converts the power control voltage data output from the multiplier 109 from a digital signal into an analogue signal. The power control section 118 controls the source voltage supplied to the power terminal 117 by the power control voltage data output from the D/A converter 115, thereby changing the source voltage supplied to the power amplifier 106.

The D/A converter 116 converts the gain control voltage data output from the adder 114 from a digital signal into an analogue signal and supplies the analogue signal to the gain control amplifier 105.

Thereby, the power amplifier 106 performs amplitude modulation and transmission power control. The gain control amplifier 105 performs gain control by a gain control voltage of the gain control amplifier 105 output from the D/A converter 116.

The power amplifier 106 has operation modes including a linear operation mode for performing power amplification by use of a linear operation domain in an input/output power characteristic and a saturating operation mode for performing power amplification by use of a saturating operation domain in the input/output power characteristic. In accordance with a control signal output from the amplitude control section 112, the power amplifier 106 operates in any of the operation modes.

A transmission power setting value Psw shown in FIG. 2 represents power for switching the operation mode. The amplitude control section 112 causes the power amplifier 106 to operate in a saturation mode when the transmission power setting value is equal to or greater than Psw and operate in a linear mode when the transmission power setting value is less than Psw.

In the saturation mode, the amplitude control section 112 maintains a gain control voltage V_{VGA} input to the gain control amplifier 105 constantly at the voltage V_{VGA.C} (see the characteristic 204), thereby constantly maintaining the power input to the power amplifier 106. In addition, the amplitude control section 112 controls transmission power by controlling the source voltage from the power amplifier 106 (see the characteristic 201).

In the meantime, in the linear mode, the amplitude control section 112 constantly maintains the source voltage of the power amplifier 106 at a voltage V_{PA,C} (see the characteristic 202). Further, the amplitude control section 112 controls the gain control voltage of the gain control amplifier 105, thereby controlling transmission power (see the characteristic 205).

The word “source voltage of the power amplifier 106” used herein means an effective value of the amplitude-modulated voltage. Thereby, the power amplifier 106 becomes able to use a transmission power dynamic range in the saturation mode and the linear mode; hence, it becomes possible to make the dynamic range of the polar modulation transmitter 100 wide.

Corrections to the gain control voltage data and the power control voltage data made by the foregoing adders 113 and 114 will now be described.

As described by reference to FIG. 2, although the power control voltage data for the power amplifier 106 and the gain control voltage data pertaining to the gain control amplifier 105 are stored in the storage section 111. However, temperature variations result in changes in optimum values of the sets of data (the characteristics 203 and 206). Accordingly, the polar modulation transmitter 100 of the present embodiment makes a correction to the control signal (the power control voltage data and the gain control voltage data) output from the amplitude control section 112 by addition of correction values ΔVp and ΔVv appropriate to detected temperature information by the adders 113 and 114. High-precision transmission power control is thereby implemented while the linearity of transmission power is maintained between operation modes.

Next, operation pertaining to the correction of the gain control voltage data and the power control voltage data is described. Values determined by adding an additional correction value output from the correction value computing section 124 to a reference correction value, which is output from the amplitude correction section 122, through use of adders 125 and 126 are used as correction values added to the gain control voltage data pertaining to the gain control amplifier 105 and the power control voltage data pertaining to the voltage amplifier 106 by the adders 113 and 114. The reference correction value is an example of a first correction value, and the additional correction value is an example of a second correction value.

The temperature sensor 130 detects a temperature and outputs a temperature detection voltage. The A/D converter 129 converts the temperature detection voltage output from the temperature sensor 130 from an analogue signal into a digital signal and outputs the signal to the amplitude correction section 122.

The mode determination section 110 also determines an operation mode of the power amplifier 106 from the transmission power setting value input from the transmission power setting input terminal 108. For instance, in the embodiment shown in FIG. 2, the operation mode is determined to be a saturation mode when the transmission power setting value is equal to or greater than Psw and determined to be a linear mode when the transmission power setting value is less than Psw.

In accordance with the operation mode (the saturation mode/the linear mode) determined by the mode determination section 110, the selector 121 selects the reference correction value output to the amplitude correction section 122 from the storage section 119 and the storage section 120. In the embodiment shown in FIG. 2, the storage section 119 stores the reference correction value (ΔVp) for the power control voltage data pertaining to the power amplifier 106 appropriate to a predetermined temperature or temperature range, and the storage section 120 stores a reference correction value (ΔVv) for the gain control voltage data pertaining to the gain control amplifier 105 appropriate to the predetermined temperature or temperature range.

The amplitude correction section 122 acquires the reference correction value appropriate to the temperature output from the A/D converter 129 from the storage section 119 and the storage section 120 selected by the selector 121. The amplitude correction section 122 acquires a reference correction value in accordance with the operation mode determined by the mode determination section 110 and the temperature detected by the temperature sensor 130; and makes corrections to the control signal output from the amplitude control section 112 in accordance with the correction value.

Since the control signal is corrected on the basis of the operation mode of the power amplifier and a detected state quantity by such a configuration, the polar modulation transmitter 100 can follow a change in transmission power at high speed while lessening an error in transmission power.

Moreover, the power detection section 128 detects the output power of the power amplifier 106. The A/D converter 127 converts the detected output power from an analogue signal into a digital signal.

The power value comparison section 123 compares the power value output from the A/D converter 127 with the transmission power setting value input from the transmission power setting input terminal 108 and inputs a difference to the correction value computing section 124. The correction value computing section 124 computes an additional correction value for the power control voltage data pertaining to the power amplifier 106 and an additional correction value for the gain control voltage data pertaining to the gain control amplifier 105, and outputs respective additional correction values to the adders 125 and 126.

The adders 125 and 126 add the additional correction values output from the correction value computing section 124 to the reference correction values output from the amplitude correction section 122 and output the additional correction values to the adders 113 and 114. The adders 113 and 114 add the correction values output from the adders 125 and 126 to the control signal output from the amplitude control section 112, thereby making a correction to the control signal.

By such a configuration, the reference correction value output from the amplitude correction section 122 is further corrected by utilization of a feedback loop reflecting a result of a comparison between the output power of the power amplifier and the transmission power setting value; hence, the polar modulation transmitter 100 can perform high-precision transmission power control. Moreover, since the reference correction value previously selected by temperature information is corrected by the additional correction value, the amount of correction made by the feedback loop becomes smaller, so that a convergence time of the feedback is shortened; hence, the polar modulation transmitter 100 can follow a change in transmission power at high speed.

The present embodiment has described the case where the reference correction value is corrected in the saturation mode solely by the power control voltage data pertaining to the power amplifier 106 and corrected in the linear mode solely by the gain control voltage data pertaining to the gain control amplifier 105. However, the reference correction value of the power control voltage data pertaining to the power amplifier 106 and the reference correction value for the gain control voltage data pertaining to the gain control amplifier 105 may also be corrected in both modes.

Moreover, in that case, when the correction value for the saturation mode differs from the correction value for the linear mode, the selector 121 has the function of selecting a reference correction value for the saturation mode and a reference correction value for the linear mode from each of the storage section 119 and the storage section 120 rather than selecting the storage section 119 and the storage section 120.

According to such a first embodiment of the present invention, since the control signal is corrected on the basis of the operation mode of the power amplifier and the detected state quantity, a change in transmission power can be followed at high speed while an error in transmission power is lessened.

The present embodiment has described the case where corrections are made to both the gain control voltage data and the voltage control voltage data. However, an effect of a reduction in the error of transmission power can be yielded solely by at least one of the sets of data.

### Second Embodiment

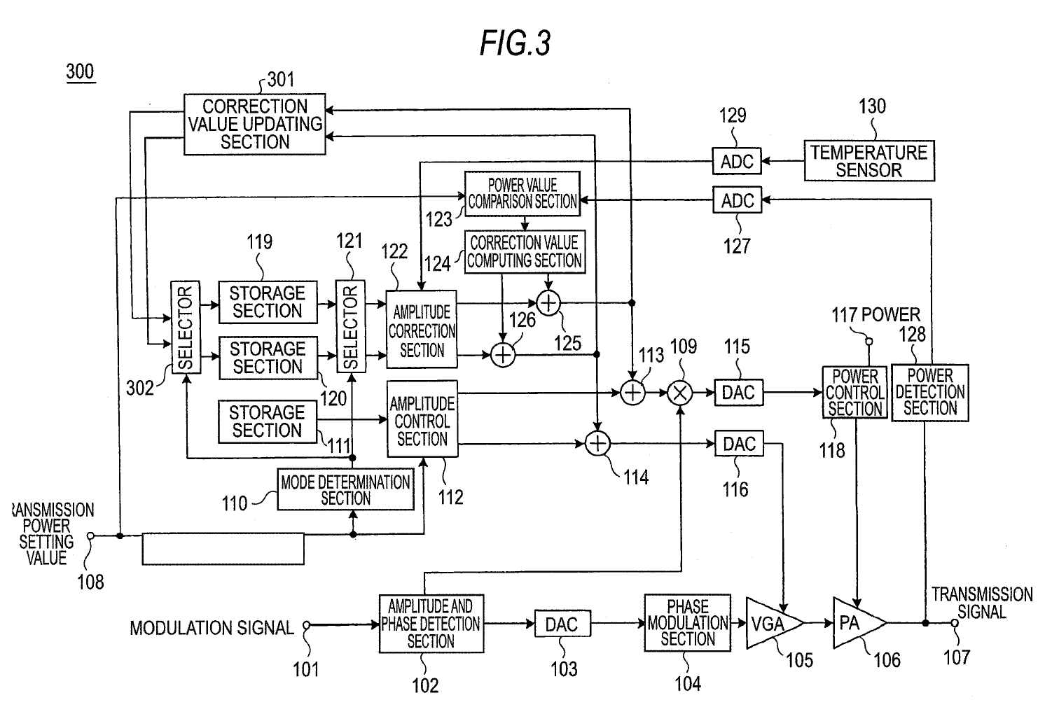

FIG. 3 is a block diagram showing the general configuration of a polar modulation transmitter of a second embodiment of the present invention. The same reference numerals are assigned to an overlap between FIG. 3 and FIG. 1 described in connection with the first embodiment.

As shown in FIG. 3, a polar modulation transmitter 300 of the present embodiment has the modulation signal input terminal 101; the amplitude and phase detection section 102; the D/A converters (DACs) 103, 115, and 116; the phase modulation section 104; the gain control amplifier (VGA) 105; the power amplifier (PA) 106; and the transmission signal output terminal 107.

The polar modulation transmitter 300 has the transmission power setting input terminal 108; the multiplier 109; the mode determination section 110; the storage sections 111, 119, and 120; the amplitude control section 112; the adders 113, 114, 125, and 126; the power input terminal 117; the power control section 118; the selector 121 and a selector 302; the amplitude correction section 122; the power value comparison section 123; the correction value computing section 124; the A/D converters (ADCs) 127 and 129; the power detection section 128; the temperature sensor 130; and a correction value updating section 301.

Operation of the polar modulation transmitter 300 will now be described by reference to FIG. 3.

The correction value updating section 301 acquires a reference correction value for the power control voltage data pertaining to the power amplifier 106 output from the adder 125 and a reference correction value for the gain control voltage data pertaining to the gain control amplifier 105 output from the adder 126, and outputs the values as updated reference correction values to the selector 302. The selector 302 outputs an updated value from the correction value updating section 301 selectively to the storage sections 119 and 120 in accordance with a result of determination of the operation mode made by the mode determination section 110.

The correction value for the power control voltage data pertaining to the power amplifier 106 and the correction value for the gain control voltage data pertaining to the gain control amplifier 105 output from the adders 125 and 126 are additionally corrected by the additional correction value output from the correction value computing section 124; hence, the value is a more accurate correction value. Therefore, a more accurate correction value can be used as a reference correction value.

According to such a second embodiment of the present invention, the correction value updating section 301 updates, as a new reference correction value, a correction value acquired by further correcting the reference correction value output from the amplitude correction section 122 by an additional correction value output from the correction value computing section 124, and supplies the correction value to the storage sections 119 and 120. Therefore, even when transmission is temporarily suspended or when power of the transmitter is turned off, the updated reference correction value is retained, and the accuracy of the reference correction value is increased, so that a change in transmission power can be followed at higher speed. Even when an optimum correction value is changed for reasons of a secular change, or the like, the reference correction value is updated to an optimum correction value; hence, tracking of a high-speed change in transmission power can be maintained.

### Third Embodiment

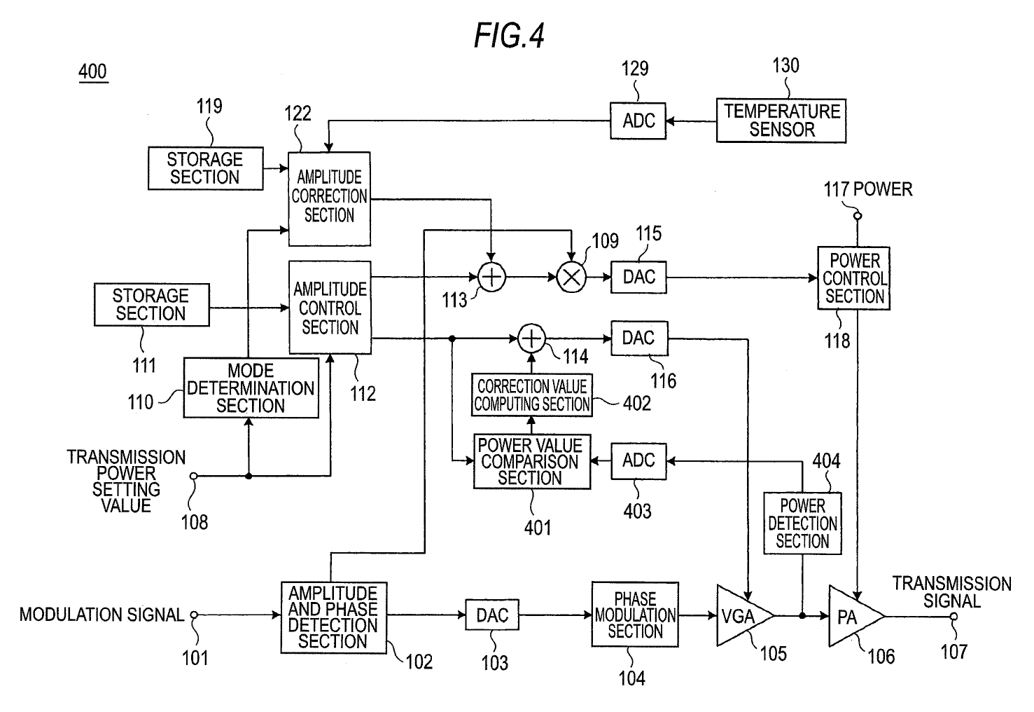

FIG. 4 is a block diagram showing the general configuration of a polar modulation transmitter of a third embodiment of the present invention. The same reference numerals are assigned to an overlap between FIG. 4 and FIG. 1 described in connection with the first embodiment.

As shown in FIG. 4, a polar modulation transmitter 400 of the present embodiment has the modulation signal input terminal 101; the amplitude and phase detection section 102; the D/A converters (DACs) 103, 115, and 116; the phase modulation section 104; the gain control amplifier (VGA) 105; the power amplifier (PA) 106; and the transmission signal output terminal 107.

The polar modulation transmitter 400 has the transmission power setting input terminal 108; the multiplier 109; the mode determination section 110; the storage sections 111 and 119; the amplitude control section 112; the adders 113 and 114; the power input terminal 117; the power control section 118; the amplitude correction section 122; a power value comparison section 401; a correction value computing section 402; an A/D converter (ADC) 403 and the A/D converter 129; a power detection section 404; and the temperature sensor 130.

The power detection section 404 functions as an example of a second power detection section, and the power value comparison section 401 and the correction value computing section 402 function as an example of a third correction section.

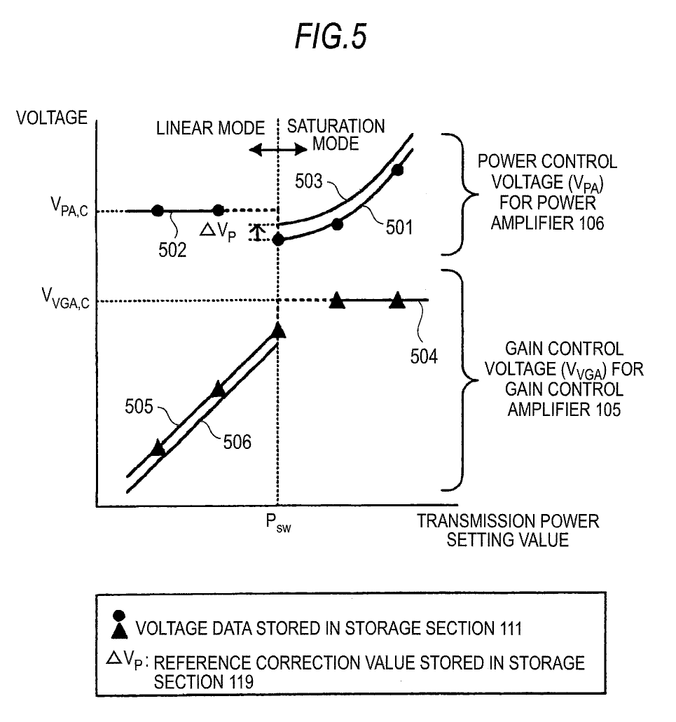

FIG. 5 is an explanatory view of operation of the polar modulation transmitter of the third embodiment of the present invention, showing voltage data stored in the storage sections 111 and 119 of the polar modulation transmitter 400. A characteristic 501 designates a characteristic curve of a power control voltage of the power amplifier 106 achieved in a saturation mode; a characteristic 502 designates a characteristic curve of the power control voltage of the power amplifier 106 achieved in a linear mode; a characteristic 503 designates a characteristic curve of the power control voltage of the power amplifier 106 achieved in the saturation mode when a temperature change arises; a characteristic 504 designates a characteristic curve of a gain control voltage of the gain control amplifier 105 achieved in the saturation mode; a characteristic 505 designates a characteristic curve of the gain control voltage of the gain control amplifier 105 achieved in the linear mode; and a characteristic 506 designates a characteristic curve of the gain control voltage of the gain control amplifier 105 achieved in the linear mode when a temperature change arises.

An embodiment shown in FIG. 5 provides an example showing, in a saturation mode, a temperature characteristic for which only the power amplifier 106 requires a correction and, in a linear mode, a temperature characteristic for which only the gain control amplifier 105 requires a correction.

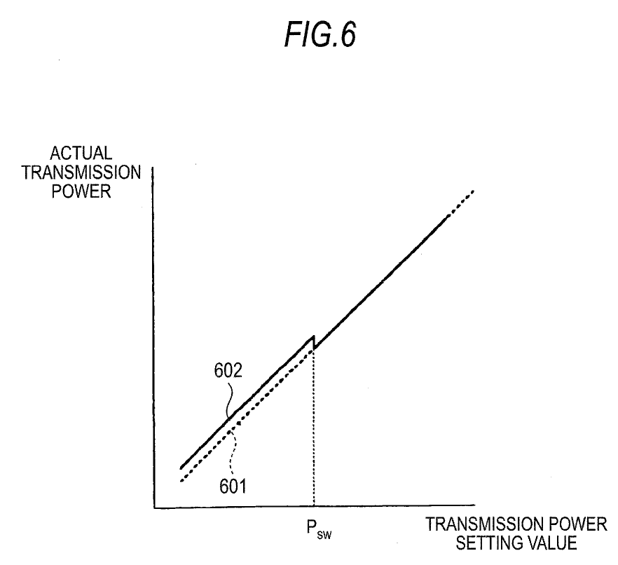

Operation of the polar modulation transmitter 400 will now be described by reference to FIGS. 5 and 6.

A correction value output from the correction value computing section 402 is used as a correction value added to the gain control voltage data pertaining to the gain control amplifier 105 output from the amplitude control section 112, and a correction value output from the amplitude correction section 122 is used as a correction value added to the power control voltage data pertaining to the power amplifier 106.

The power detection section 404 detects output power of the gain control amplifier 105. The A/D converter 403 converts the detected output power from an analogue signal into a digital signal.

The power value comparison section 401 compares the power value output from the A/D converter 403 with the gain control voltage data input from the amplitude control section 112 and inputs a difference to the correction value computing section 402. The correction value computing section 402 computes a correction value for the gain control voltage data pertaining to the gain control amplifier 105 and outputs the correction value to the adder 114.

The adder 114 adds the correction value output from the correction value computing section 402 to the gain control voltage data output from the amplitude control section 112, thereby making a correction to the gain control voltage data.

The amplitude correction section 122 acquires, from the storage section 119, a reference correction value appropriate to the operation mode determined by the mode determination section 110 and the temperature information output from the temperature sensor 130 by way of the A/D converter 129.

In the embodiment shown in FIG. 6, the storage section 119 stores a reference correction value (ΔVp) for the power control voltage data pertaining to the power amplifier 106 appropriate to a predetermined temperature or temperature range.

According to such a third embodiment of the present invention, the gain control signal input to the gain control amplifier is corrected by use of the feedback loop, and the power control signal input to the power amplifier corrects the power control signal that controls the power of the power control amplifier in accordance with the detected state quantity.

A signal amplified by the gain control amplifier 105 is a constant envelope, and a time constant of the feedback loop is kept small; hence, the time constant of the feedback loop can be reduced, and a change in transmission power can be followed at high speed. Consequently, since an error in power control performed by the gain control amplifier 105 is kept small at all times, the essential requirement for the amplitude correction section 122 is to make a correction solely to the power amplifier 106. Therefore, when a correction value used for correcting a temperature characteristic of the gain control amplifier 105 is not linear with respect to a temperature and a feedback loop is required and when a correction value used for correcting a temperature characteristic of the power amplifier 106 is linear with respect to a temperature and the feedback loop is not required, the scale of a circuit can be made compact.

In the first through third embodiments, the gain control amplifier may also be implemented by use of another gain control section, such as a gain-variable attenuator.

Descriptions have been provided by reference to the case where the polar modulation transmitter of the first through third embodiments makes a correction to the temperature characteristic. However, a correction may also be made in accordance with various states, such as a frequency characteristic and a source voltage characteristic. Corrections complying with various states are implemented by the amplitude correction section 122 outputting a correction value appropriate to a state quantity through use of; for instance, a state quantity detection section that detects the quantity of a state of the power amplifier.

### INDUSTRIAL APPLICABILITY

The polar modulation transmitter and the polar modulation transmission method of the present invention yield an advantage of the ability to follow a change in transmission power at high speed while lessening an error in transmission power, and are useful for a wireless communications device, and the like.

1. A polar modulation transmitter, comprising:
an amplitude and phase detection section that separates an input modulation signal into phase information and amplitude information;
a phase modulation section that modules a predetermined carrier wave signal in accordance with the phase information and that outputs a phase-modulated signal;
a gain control amplifier that amplifies the phase-modulated signal;
a power amplifier that has operation modes including a linear operation mode for performing power amplification by use of a linear operating domain in an input-output power characteristic and a saturation operation mode for performing power amplification by use of a saturation operation domain in the input-output power characteristic and that amplifies a signal output from the gain control amplifier;
a transmission power control section that outputs control signals including a gain control signal for controlling a gain of the gain control amplifier and a power control signal for controlling a source voltage of the power amplifier in accordance with a transmission power setting value for designating transmission output power so as to cause the power amplifier to operate in any one of the operation modes;
a power supply section that subjects the power control signal to amplitude modulation in accordance with the amplitude information and that supplies the amplitude-modulated power control signal to the power amplifier;
a state quantity detection section that detects a state quantity representing a state of the power amplifier;
an operation mode determination section that determines an operation mode of the power amplifier in accordance with the transmission power setting value; and
a first correction section that acquires a first correction value in accordance with the determined operation mode and the detected state quantity, and that corrects the control signal in accordance with the first correction value.

2. The polar modulation transmitter according to claim 1, further comprising:
a first power detection section that detects output power of the power amplifier; and
a second correction section that compares the output power detected by the first power detection section with the transmission power setting value to calculate a second correction value, and that corrects the first correction value in accordance with the second correction value.

3. The polar modulation transmitter according to claim 2, further comprising:
a correction value updating section that updates, as a new first correction value, the first correction value corrected by the second correction section and that supplies the new first correction value to the first correction section.

4. The polar modulation transmitter according to claim 1, further comprising:
a second power detection section that detects output power of the gain control amplifier;
a third correction section that compares the output power detected by the second power detection section with a gain control signal output from the transmission power control section to calculate a third correction value, and that corrects the gain control signal in accordance with the third correction value,
wherein the first correction section corrects the power control signal in accordance with the first correction value.

5. The polar modulation transmitter according to claim 1, further comprising:
a storage section that stores a correction value appropriate to the operation mode and the state quantity,
wherein the first correction section reads the correction value stored in the storage section to acquire the first correction value.

6. The polar modulation transmitter according to claim 1, wherein the state quantity detection section has a temperature sensor for detecting a temperature.

7. A wireless communications device having the polar modulation transmitter according to claim 1.

8. A polar modulation transmission method, comprising the steps of:
separating an input modulation signal into phase information and amplitude information;
modulating a predetermined carrier wave signal in accordance with the phase information and outputting a phase-modulated signal;
amplifying the phase-modulated signal by a gain control amplifier;
amplifying a signal output from the gain control amplifier by a power amplifier that has operation modes including a linear operation mode for performing power amplification by use of a linear operating domain in an input-output power characteristic and a saturation operation mode for performing power amplification by use of a saturation operation domain in the input-output power characteristic;
outputting control signals including a gain control signal for controlling a gain of the gain control amplifier and a power control signal for controlling a source voltage of the power amplifier in accordance with a transmission power setting value for designating transmission output power so as to cause the power amplifier to operate in any one of the operation modes;
subjecting the power control signal to amplitude modulation in accordance with the amplitude information and supplying the amplitude-modulated power control signal to the power amplifier;
detecting a state quantity representing a state of the power amplifier;
determining an operation mode of the power amplifier in accordance with the transmission power setting value; and
acquiring a first correction value in accordance with the determined operation mode and the detected state quantity and making a correction to the control signal in accordance with the first correction value.
